(19) United States
(12) Patent Application Publication
(10) Pub. No.: US 2007/0255468 A1
(43) Pub. Date: Nov. 1, 2007

(54) Vehicle window control system

(75) Inventors: Eric R. Strebel, Southfield, MI (US); James Dulgerian, Troy, MI (US); Nathan P. Lucas, Shelby Township, MI (US)

Correspondence Address: BRINKS HOFER GILSON & LIONE, P.O. BOX 10395, CHICAGO, IL, 60610, US

(73) Assignee: ALPS AUTOMOTIVE, INC.

(21) Appl. No.: 11/411,453

(22) Filed: Apr. 26, 2006

(51) Int. Cl. G06F 17/00

(52) U.S. Cl. 701/49; 701/36

(57) ABSTRACT

A vehicle window control system is configured to move a window to a selected position or until a desired change in position has been achieved. The system includes an input device and a control device. The input device generates a signal indicative of a desired window movement. The switch analyzes the received input signal to detect an input mode, and generates an output signal that causes a window to move in accordance with the received signal data.

### BACKGROUND OF THE INVENTION

1. Technical Field

This invention relates to a control system, and more particularly to a system that controls a vehicle window.

2. Related Art

Window controls enable users to open and close a window. In some systems only an on or off switch is used. In these systems, a user must continue to engage a window control switch to control a window position. In some systems, where a precise window adjustment is desired, a user must watch the window to control a precise adjustment. In these situations, a driver may become distracted. Therefore, a need exists for an improved window control system.

### SUMMARY

A system for controlling a vehicle window moves a window to a selected position or until a desired change in position is reached. The system includes an input device and a multi-mode switch. The input device generates a signal indicative of a desired window movement. The switch analyzes the received input signal to detect an input mode, and generates an output signal that causes a window to move in accordance with the received signal.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a partial schematic of a vehicle door.

FIG. 2 is a block diagram of a vehicle window control system incorporated into a vehicle.

FIG. 3 is a block diagram of a vehicle window control system.

FIG. 4 is a schematic of an input device.

FIG. 5 is a second block diagram of a vehicle window control system.

FIG. 6 is a flowchart of a vehicle window control system.

FIG. 7 is a diagram of an alternate input device.

FIG. 8 is a diagram of an absolute movement of a vehicle window.

FIG. 9 is a diagram of a relative movement of a vehicle window.

FIG. 10 is a diagram of vibration feedback.

FIG. 11 is alternate diagram of a vehicle window control system.

### DETAILED DESCRIPTION OF THE PREFERRED EMBODIMENTS

A window control system may receive data indicating a desired window position. The system may process the data to determine a mode of operation. Based on the mode of operation, the system evaluates the data to determine an amount of window movement necessary to achieve a desired window position. Through various input modes, the system permits a user to change a window's position without having to monitor the time period of movement or to visual confirm the window's position.

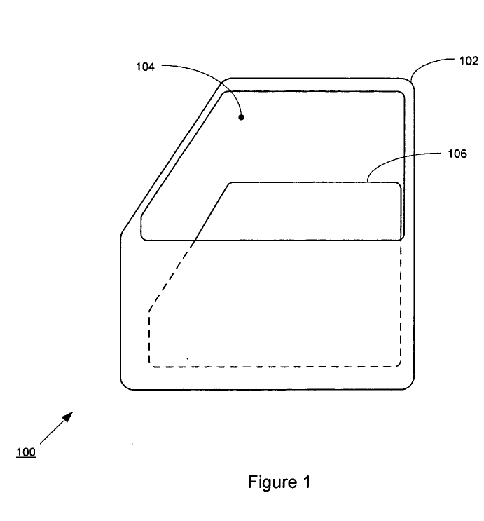

FIG. 1 is a partial schematic of a vehicle door 100. The vehicle door 100 may include a frame 102 having a window opening 104. A groove (not shown) may be formed within frame 102 to hold and guide the movement of a rigid material 106. The rigid material 106 may be moved between a fully closed position to a fully opened position. The rigid material 106 may comprise a window and may be a translucent or transparent material, such as glass, an acrylic plastic sheet (e.g., Plexiglas®), a transparent plastic laminated between sheets of clear glass (e.g., safety glass), or a semi-transparent material, to which a color may be added which may impede some of the spectrum of light.

A vehicle window control system may be operatively connected to a device or structure for transporting persons or things, such as a vehicle. The system may be coupled with a vehicle's on-board computer, such as an electronic control unit, an electronic control module, or a body control module. The vehicle window control system may communicate with existing circuitry of the vehicle using one or more protocols. Some of the protocols may include J1850VPW, J1850PWM, ISO, ISO9141-2, ISO14230, CAN, High Speed CAN, MOST, LIN, IDB-1394, IDB-C, D2B, Bluetooth, TTCAN, TTP, or the protocol marketed under the trademark FlexRay. Configuration data or alternative settings, such as operation in a standard legacy mode, for the vehicle window control system may be accessed through a user interface, such as a window control interface, or a vehicle's graphic user interface (e.g., infortainment center).

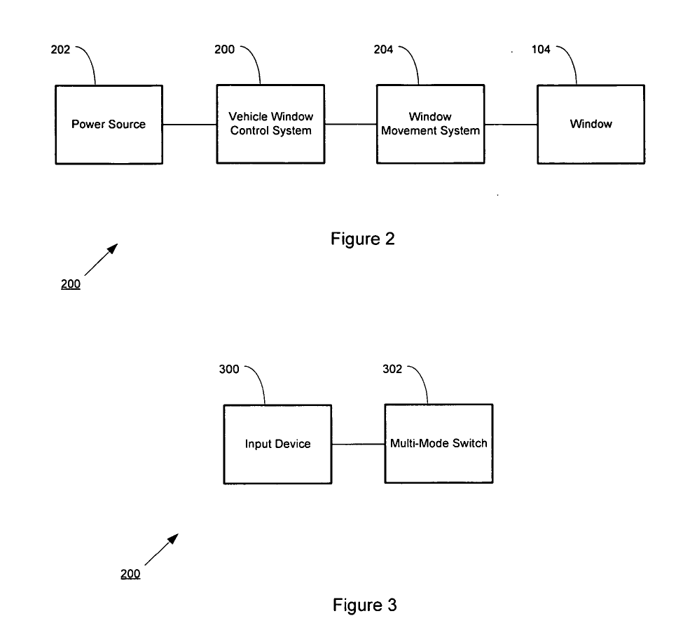

FIG. 2 is a block diagram of a vehicle window control system 200 mechanically coupled to a vehicle. Vehicle window control system may be coupled to a power source 202, and/or a window movement system 204. The window movement system 204 may receive a window position signal from the vehicle window control system 200 that causes a window 106 to change its position. Power may be supplied directly to the window movement system 204 (not shown); it may be sourced from the vehicle's on-board computer, such as an electronic control unit, an electronic control module, or a body control module (not shown); or it may be sourced from the vehicle window control system 200. Window movement system 204 may comprise an electromechanical system, such as a motor and a system of gears, a system pertaining to liquid pressure and flow, such as hydraulics, or a system pertaining to or using a gas, such as pneumatics, that may raise or lower a window while keeping it level.

FIG. 3 is a block diagram of a vehicle window control system 200. The vehicle window control system 200 may comprise an input device 300 and a multi-mode switch 302. Input device 300 may comprise a touch sensitive interface which generates one or more digital or analog signals. These signals may be processed to change a desired window position, and may comprise absolute data or relative data. Absolute data may comprise window position data that is associated with a specific point or specific location on a touch sensitive interface. Relative data is data that is linked to the movement across the touch sensitive interface, but not the position of the window. It may comprise window position data that is related to the distance between a first and a second point on the touch sensitive interface. The second point may be spaced apart from the first point with other points in between, such that the second point is the point located furthest away from the first point on the touch sensitive interface. Alternatively, the second point may be any of the points located between the first point and the point located furthest away from the first point on the touch sensitive interface. When a user's touch moves across the touch sensitive interface, the window may move to reflect the movement against the touch sensitive interface.

Multi-mode switch 302 is configured to receive and automatically analyze signals generated by input device 300. In addition to the window position, signals may comprise information relating to an input mode. This information may indicate window position associated with positions on the input device 300, time variations between touches on input device 300, and/or the spatial relationship of touches on input device 300. All or a portion of this data may be evaluated by multi-mode switch 302 to detect the input mode and/or valid contacts with input device 300. Based on the detected input mode, multi-mode switch 302 may process the received data and may output a signal to a window position system 204 that causes a selected window 104 to move to the user desired position.

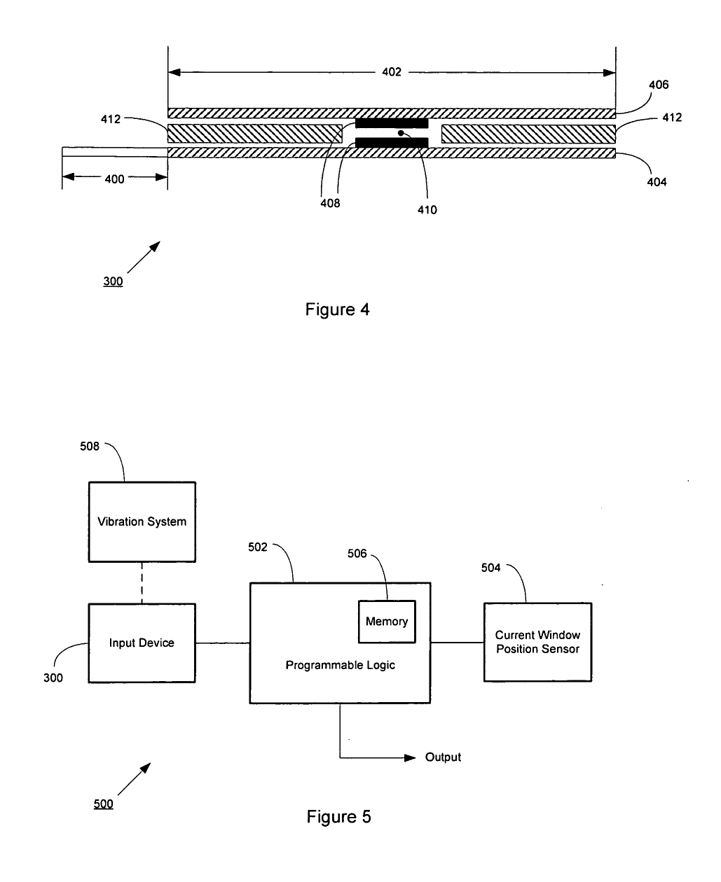

FIG. 4 is a schematic of an input device 300. Input device 300 may comprise a connector 400 which connects to multi-mode switch 302, and an elongated input region 402. Connector 400 may comprise a flexible printed circuit, a unitary ribbon wire, and/or standard electrical wiring. Elongated input region 402 may comprise multiple layers. A first layer may comprise a static layer 404 and may be constructed such that it does not flex during operation. Alternatively, the static layer 404 may be constructed from a flexible material that is affixed to a rigid back (not shown), such as aluminum, steel, plastic, glass, and/or fiberglass, or that is affixed directly to an instrument housing which provides the necessary support. A second layer may comprise a membrane layer 406 which is a thin pliable layer that may flex during operation. Electrical contacts 408 are affixed to the membrane layer 406 and/or the static layer 404, such that upon actuation of the membrane layer physical contact occurs between the contacts 408. Once the actuating force is removed, the membrane layer 406 and the static layer 408 separate as a result of the membrane layer's 406 flexible material, thereby breaking the electrical connection. An air gap 410 may separate the electrical contacts 408 when an actuating force is absent.

In FIG. 4, the length of the electrical contacts 408 may be less than the length of the elongated input region 402. Additionally, non-conductive spacers 412 may be disposed between membrane layer 406 and static layer 404. The length of the non-conductive spacers 412 may also be less than the length of the elongated input region 402 and may be positioned between adjacent electrical contacts 408. Other components may be added to the elongated input region 402 to aid use. A graphic layer (not shown) may be disposed on top of the membrane layer 406. The graphic layer may include a thin layer polyester or polycarbonate on which directional or other useful information has been printed. The graphic layer could also include a layer of elastomer to provide a three-dimensional look and feel to the input region 402. A separate tactile layer (not shown) may be disposed between the membrane layer 406 and static layer 404 to provide a user with a response perceptible to a sense of touch upon actuation.

Some vehicle window control systems are capable of using different types of input devices 300. An elongated resistive switch may be used to generate the touch sensitive input signals. An elongated resistive switch may comprise a flexible conductive layer, and a flexible resistive layer separated by an air gap. The air gap may run through the entirety of the layers. When a surface portion of the conductive layer is actuated, the conductive and resistive layers may make electrical contact to generate a signal. Each actuation of the resistive switch may generate a unique value. Alternatively, an elongated capacitive switch may be used to generate the touch sensitive input signals. The elongated capacitive switch may comprise a plurality of separated plates. As one of the plates is moved towards another plate (usually in a fixed position), a change in capacitance may be detected, and a signal indicative of the location pressed on the input device 300 may be generated. A comparator may be used to detect the change in capacitance.

Some vehicle window control systems may also use different components to determine an input mode as well as the amount of movement required for an associated window. FIG. 5 is an alternate vehicle control system 500. An alternative vehicle control system 500 may comprise an input device 300, programmable logic 502, and a current window position sensor 504. Programmable logic 502 may comprise multiple ports for interfacing one or more input devices 300, and is configured to receive the signal or signals generated by the one or more input devices 300. The data received by programmable logic 502 may be received in a time that occurs at or near the same rate of time perceived by a human, such as real-time, near real-time, or in delayed time (e.g., batch). The received data may be preprocessed to condition the data. Preprocessing of the data may include filtering corrupt and invalid inputs based on a location or locations touched by a user on the input device 300, the time variations between user touches on the input device 300, and/or the spatial relationship of touches on the input device 300. In addition to detecting corrupt or invalid inputs, programmable logic 500 may use all or a portion of the data to automatically detect an input mode.

When operating in an absolute input mode, each position on the input device 300 corresponds to an associated window position. One such situation may include contact points being associated with a predetermined window position, such as a one-quarter open window position, a one-half open window position, and a three-quarters open window position. Programmable logic 502 may be configured to detected the absolute data and generate a signal that causes the window 104 to move to the associated window position. When a plurality of inputs are received from adjacent contact points on input device 300, which are actuated at substantially the same time, programmable logic 502 may generate a window position signal corresponding to an associated window position of one of the contact points that bounds the plurality of actuated contact points. Alternatively, programmable logic 502 may estimate the associated window position to be at a location between the associated positions of the individual contact points that were actuated at substantially the same time, such as a midway point, and generate an associated window position signal.

When operating in a relative mode, the movement across input device 300 corresponds to an amount of window movement. The amount of window movement may be proportional to the distance between a first point contacted on the touch sensitive interface and a second point on the touch sensitive interface. These points may respectively correspond to the point where a user initiates contact with the touch sensitive interface, and the point where the user discontinues contact with the touch sensitive interface after moving its finger some distance, in continuous contact with the touch sensitive interface. Alternatively, these points may correspond to two separate actuated contact points spaced apart from one another on input device 300 occurring within a predetermined time period. A proportionality factor may be related to the size of the elongated input region (e.g., for longer input regions, the proportion may be smaller, such as 2:1, while for shorter input regions, the proportion may be larger, such as 4:1). The proportionality factor may be programmed by the manufacturer of the vehicle window control system 400, or may be customizable by a user.

Current window position sensor 504 may monitor the current position of a window and transmit or feedback position data to programmable logic 502. Position data may comprise directional data and/or an amount of window movement. In some systems, the window position data may include the number of revolutions performed by a window position system motor. In these systems, a two phase hall effect sensor may be used to monitor to detect a rotation direction. The difference between the Hall Effect sensors may be used to detect whether a motor is rotating clockwise or counterclockwise.

Programmable logic 502 may comprise a memory 506 that is configured to store position data received from window position sensor 504. Memory 506 may store all or a portion of the window position data. Programmable logic 502 may access memory 506 via a bidirectional, serial, or parallel bus and process the stored data to obtain a current window position. Programmable logic 502 may compare window position data received from input device 300 to the current window position data stored in memory 506. Based on the comparison result, programmable logic 502 may generate a signal to move an associated window 104 to the user desired position.

Some vehicle window control systems 500 may include a vibration system 508. In these systems, the elongated input region may be mounted in a cradle such as to permit minute movement of the input region. A short-vibration feedback device may be attached to the input region to deliver a response perceptible to a user's sense of touch. When a user touches the input region of input device 300, a signal may be transmitted to the feedback device which causes the input region to vibrate. The feedback device may be configured such that the vibration sensed by the user appears to originate from the location on the input region that the user has touched. The feedback device may be further configured to generate one or more vibrations separated by a predetermined time period for the amount of time that the user's finger is in contact with the input region. If the user moves its finger along the input region, feedback device may generate vibration signals at predetermined measured intervals to indicate that the relative input mode is active.

A vehicle window control system may be coupled to a plurality of window selection switches. Each selection switch may correspond to a vehicle window that may be opened or closed. Any combination of window switches may be selected at one time, and controlled through the input device of the vehicle control window system. In the case that no switch is selected, a vehicle window control system may be programmed to default to control only a driver's window. A timer, internal or external to the vehicle window control system may monitor inactivity of the system. The vehicle window control system may be programmed to return to the default settings upon receiving a signal indicating that the inactivity time has expired. Although the vehicle window control system has been described in connection with a vehicle window, the vehicle window control system may be used in a similar manner to a control a vehicle's sunroof.

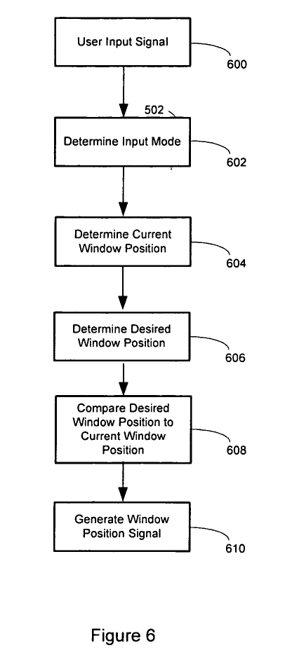

FIG. 6 is a flowchart of a vehicle window control system. The system operates by receiving an input signal indicative of a user desired window position, detecting an input mode associated with the input signal, comparing the desired window position to a current window position, and generating an output signal to move an associated window to the desired window position. At act 600 a user input may be received by the vehicle window control system at a touch sensitive input device. In some vehicle window control systems, when an input is received at the touch sensitive input device, a response perceptible to a user's sense of touch may be generated causing the input device to vibrate. The vibration may indicate to a user that the input has been received. Depending on how the user has made contact with the input device, one or more vibrations may be generated over a measured distance or time period. The touch sensitive input device may generate and transmit a signal or signals, representative of the input, to a control device. The signal or signals transmitted to the device may indicate a desired window position or a desired change in window position.

At act 602 the control device receives the signal or signals from the input device and detects an input mode. The input mode may correspond to an absolute mode or a relative mode. The input mode may be detected from data content transmitted to the control device. The data content may include a location or locations touched by a user on the input device, time variations between touches on input device, and/or the spatial relationship of touches on input device.

At act 604 a current window position may be detected. The control device may determine the current window position based on data received from a window position sensor. The data received from the window position sensor may include a direction component and a window displacement component. In some vehicle window control systems, the window displacement component may correspond to the number of revolutions undergone by a motor that controls the movement of an associated window.

At act 606 a desired window position may be determined. When the control device has detected that it is operating in an absolute mode, each touch position of the input device corresponds to an associated window position. The control device may compare the corresponding detected associated window position with the current window position. If a difference in position is detected, the control device generates a window position signal that may be received by a window position system and which will cause an associated window to move the necessary amount until the desired window position is achieved.

When the control device has detected that it is operating in a relative mode, the input data corresponds to a desired amount of window displacement. The control device may convert the relative data to a desired window position. To convert the relative data to a desired window position, the control device may add or subtract the displacement data from the current window position data. At act 608 a comparison is made between the desired window position and the current window position. The comparison may occur in real-time or in batch time. At act 610 a window position signal may be generated if a difference in position is detected as a result of the comparison. The window position signal may be received by an additional system that causes an associated window to move to a desired position, whether that position is an absolute position or a relative distance.

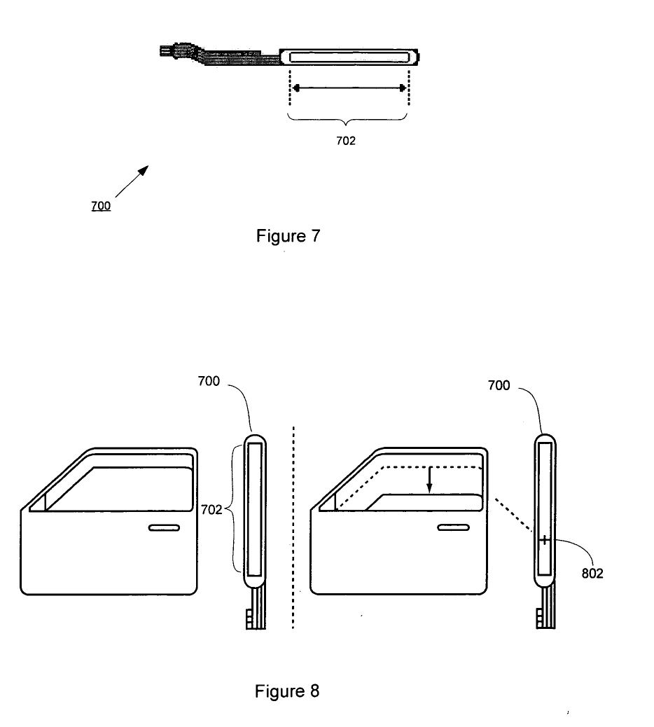

FIG. 7 is a diagram of an alternate input device 700. Alternate input device 700 comprises a flexible strip of inline momentary switches, such as the FeatherTouch Sensor™ manufactured by Alps Electric. Input device 700 may be configured to accept user input as a finger press on a point of the surface of input region 702 or by sliding a finger across a length of the surface of input region 702. The total length of input device 700, including input region 702 and surrounding housing, may be limited by placement practicality. In some systems, the total length of the input device may be as long as about 30 cm, and may be about 15 cm. Input region 702 may have any length of about 7.5 mm.

In an alternate vehicle window control system, input device 700 communicates with a processor, such as a vehicle's on-board computer. In such systems, firmware resident to or coupled to the processor may be stored in a read-only memory (“ROM”) and/or a random access memory (“RAM”). The processor may be programmed to receive and store input from a user, and window position changes from a digital encoder on a power window drive motor. By analyzing stored user input, the firmware may determine which input mode is intended by the user. Based on the input mode, the processor commands a selected window to move appropriately until an absolute position or change in position relative to the amount of movement across the input device is achieved. Data received from digital encoder may be used by processor to determine when the desired window position is achieved.

FIG. 8 is a diagram of an absolute movement of a vehicle window. To move a selected window a large distance, a user may operate the system in an absolute mode. In this situation, the point on the input device 700 furthest from the user corresponds to a fully closed window, and the point on the input device closest to the user corresponds to a fully open window. As the user touches a point or location on the input device 700, the selected window is moved to a position associated with the touched position. In FIG. 8, the left side diagram illustrates a starting window position. The right side diagram of FIG. 8 illustrates an ending window position achieved through an absolute movement. The ending window position corresponds to a position 802 touched on input region 702. Input region 702 may comprise a plurality of positions, each of which are associated with a different window position.

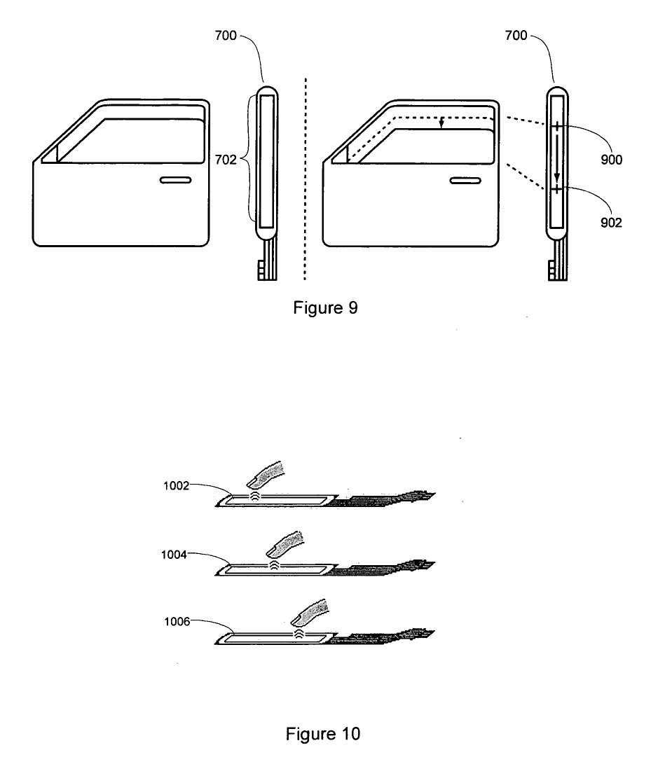

FIG. 9 is a diagram of a relative movement of a vehicle window. In FIG. 9, the left side diagram illustrates a starting window position. The right side diagram of FIG. 9 illustrates an ending window position according to a relative movement. As a user slides a finger across input region 702 from a first point 900 to a second point 902, the system determines the length of movement across input region 702 and moves the associated window an amount proportional to length of movement across input region 702.

The vehicle window control system may evaluate whether the user intends an absolute movement or relative movement by recording what part or parts of the input device 700 are touched during the period of time between an initial contact with the input device and the termination of that contact. The system may be configured to operate in an absolute mode by default. If the system detects only a narrow range of input from the input device 700, such as less than about 4 millimeters the system remains in absolute mode and window movement is commanded upon the termination of the input. If at any time during contact with the input device, a range of input data outside of the narrow range of input is detected, then the system engages the relative mode and window movement is commanded in real-time.

In some vehicle window control systems, input device 700 may rest in a cradle that allows for minute movement of input device 700. A short-vibration feedback device, such as a Force Reactor™ manufactured by Alp Electric, is attached to the cradle to deliver a response perceptible to a sense of touch. When a user touches input device 700, the vibration feedback device generates a signal perceptible to a sense of touch at the point of contact with input device 700. The signal generated by the vibration feedback device may be perceived by a user to be one or a series of brief modulations.

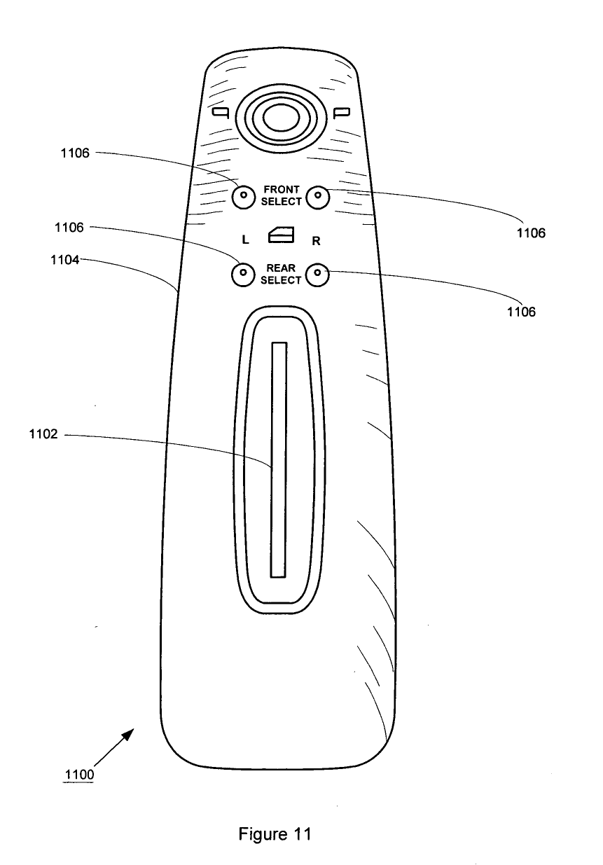

FIG. 10 is a diagram of vibration feedback. At the beginning of an input, 1002, the vibration feedback device may generate a modulation, at a point of contact, to indicate to the user that an input has been received. If the user does not move beyond input device's 700 narrow range of input, no additional feedback signals are generated. If the user selects to use the relative input mode and slides his/her finger along the surface of input device 700, modulations are generated a predetermined intervals, 1004 and 1006, to indicate that the relative mode is activated. The predetermined intervals may be spaced about 4 millimeters apart.

FIG. 11 is alternate diagram of an apparatus 1100 that controls vehicle windows. An input device 1102, such as the FeatherTouch Sensor™ may reside in a generally oblong cradle 1104. Input device 1102 communicates with one or more momentary switches 1106 and a processor (not shown) programmed with or coupled to firmware. Each momentary switch 1106 is associated with a vehicle window or a sunroof. Any combination of windows can be selected or deselected by actuating the corresponding momentary switch 1106. When more than one momentary switch 1106 is actuated, the processor may command all corresponding windows to move according to the input received at input device 1102. A light emitting diode may be positioned proximate to each of the momentary switches 1106 to indicate the actuation of the switch. When none of the momentary switches 1106 are actuated, the processor may be programmed to operate only a driver's window. Additionally, if more than one of the momentary switches 1106 are actuated and an input is not received at input device 1102 for predetermined time period, processor may cause the system to disengage the actuated momentary switches 1106 and revert to default condition, such as controlling only a driver's window.

In some vehicle window control systems the processor may be further programmed to raise or lower a selected window to a predetermined position based on a sub-region touched on the input device. In such systems, the input region may be electronically divided, such as divided into two halves. An upper portion of the input region may correspond to the portion between the middle of the input region and the position furthest away from a user. A lower portion may correspond to the portion between the middle of the input region and the position closest to a user. In this configuration, touching any portion of the upper half of the input region causes the system to raise a window to a predetermined position, such as a fully closed position. Touching any portion of the lower half of the input region causes the system to lower a selected window to a predetermined position, such as a fully opened position. Alternatively, the window control system processor may be programmed to raise or lower a selected window while an input is received on a sub-region of the input device. In this configuration, a selected window is not moved to a predetermined position, but is moved while the input is received or until the system determines that the selected window has reached its fully open or closed position.

The method shown in FIG. 6, in addition to the other methods described above, may be encoded in a signal-bearing medium, a computer-readable medium such as a memory, programmed within a device such as one or more integrated circuits, or processed by a controller, a processor, or a computer. If the methods are performed by software, the software may reside in a memory resident to or interfaced to programmable logic 502, a vehicle on-board computer, or any type of communication interface. The memory may include an ordered listing of executable instructions for implementing logical functions. A logical function may be implemented through digital circuitry, through source code, through analog circuitry, or through an analog source such as through an electrical, audio, or video signal stored or processed b logic. The software may be embodied in any computer-readable or signal bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal medium,” and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of machine-readable medium would include: an electrical connection (electronic) having one or more wires, a portable magnetic or optical disk, a volatile memory such as Random Access Memory “RAM” (electronic), a Read-Only Memory “ROM” (electronic), an Erasable Programmable Read-Only Memory (EPROM or Flash Memory) (electronic), or an optical fiber (optical). A machine-readable medium may also include a tangible medium upon which software is printed, as the software may be electronically stored as an image or in another format (e.g., through an optical scan), the compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A vehicle window control system, comprising:
an elongated touch sensitive input device; and
a switch programmed to cause a window to move according to a first mode or a second mode;
where the first mode comprises the switch causing the window to move to a position indicative of a location touched on the input device, and the second mode comprises the switch causing the window to move a distance proportional to a length of a region located between a starting contact position and an ending contact position.

2. The system of claim 1, where the switch detects the first mode or the second mode based on data received from the input device.

3. The system of claim 2, where the switch is further programmed to monitor the window's position.

4. The system of claim 3, where the switch is further programmed to cause the window to move subsequent to an input received at the input device.

5. The system of claim 3, where the switch is further programmed to cause the window to move in real-time in response to an input received at the input device.

6. The system of claim 3, where the input device further comprises a plurality of discrete switches.

7. The system of claim 6, where the second mode further comprises contact with each of the discrete switches between the starting contact position and the ending contact position.

8. A vehicle window control system, comprising:
an elongated input device comprising a plurality of touch sensitive switches;
a programmable logic programmed to receive absolute data or relative data from the input device; and
a sensor configured to sense a window position data coupled to the programmable logic.

9. The system of claim 8, where the programmable logic detects whether to generate an output signal through a comparison of the received data and the window position data.

10. The system of claim 9, where the absolute data comprises a window position signal associated with a location touched on the input device.

11. The system of claim 8, where the relative data comprises a window position signal proportional to a linear path traversed between a first contact point of the input device and a second contact point of the input device.

12. The system of claim 10, where the programmable logic is programmed to determine a window position based on the window position data and the relative data.

13. The system of claim 8, further comprising a sensor coupled to the input device that is configured to generate a tactile feedback signal.

14. (canceled)

15. (canceled)

16. (canceled)

17. (canceled)

18. A power window system, comprising:
a touch sensitive input device;
a controller that raises or lowers a window while keeping the window level;
where the touch sensitive input device comprises an absolute movement device and a relative movement device;
the absolute movement device coupled to the controller raises or lowers the window to a position associated with a position on the touch sensitive input device; and
the relative movement device coupled to the controller raises or lowers the window a relative distance linked to a movement across the touch sensitive input device.

19. The system of claim 18, where the touch sensitive input device is coupled to a vehicle.

20. The system of claim 19, where the touch sensitive input device comprises a touch sensitive surface.

21. A system that controls a vehicle window, comprising:
means for generating a desired window position signal or a change in position signal;
means for detecting the type of received input signal; and
means for moving an associated window in accordance with the received input signal.
